(19) United States
(12) Patent Application Publication
(10) Pub. No.: US 2024/0330201 A1
(43) Pub. Date: Oct. 3, 2024

(54) ADDRESS TRANSLATION IN A MULTI-NODE COMPUTING SYSTEM

(71) Applicant: Samsung Electronics Co., Ltd., Suwon-si (KR)

(72) Inventors: Alan Gara, Palo Alto, CA (US); Robert Wisniewski, Ossining, NY (US); Douglas Joseph, Leander, TX (US); Samantika Sury, Westford, MA (US); Jai Dayal, Aloha, OR (US); Rolf Riesen, Forest Grove, OR (US)

(21) Appl. No.: 18/534,532

(22) Filed: Dec. 8, 2023

Related U.S. Application Data
(60) Provisional application No. 63/455,550, filed on Mar. 29, 2023.

(51) Int. Cl. G06F 12/1027

(52) U.S. Cl. CPC G06F 12/1027

(57) ABSTRACT

A system and method for address translation in a multi-node computing system. In some embodiments, the system includes a first node. The first node may include: a core; and a global address translation circuit, the core including: a core processing circuit; and a memory management unit configured to map local virtual addresses to global virtual addresses, the global address translation circuit being configured to map global virtual addresses to global physical addresses.

### CROSS-REFERENCE TO RELATED APPLICATION(S)

The present application claims priority to and the benefit of U.S. Provisional Application No. 63/455,550, filed Mar. 29, 2023, entitled “LOCAL TO GLOBAL ADDRESS TRANSLATION FOR VERY SMALL ARRAYS IN A GLOBAL ADDRESS SPACE”, the entire content of which is incorporated herein by reference.

### FIELD

One or more aspects of embodiments according to the present disclosure relate to computing systems, and more particularly to systems and methods for computing with multiple nodes.

### BACKGROUND

To increase the processing capacity of a computing system, it may be advantageous to assemble large numbers of computing elements, capable of exchanging data with each other.

It is with respect to this general technical environment that aspects of the present disclosure are related.

### SUMMARY

According to an embodiment of the present disclosure, there is provided a system including: a first node, the first node including: a core; and a global address translation circuit, the core including: a core processing circuit; and a memory management unit configured to map local virtual addresses to global virtual addresses, the global address translation circuit being configured to map global virtual addresses to global physical addresses.

In some embodiments, the memory management unit includes a translation lookaside buffer for mapping local virtual addresses to global virtual addresses.

In some embodiments: the global address translation circuit is configured to map a first global virtual address range having a first size to a first global physical address range having the first size; the global address translation circuit is configured to map a second global virtual address range having the first size to a second global physical address range having the first size; the second global virtual address range is contiguous with the first global virtual address range; and the second global physical address range is not contiguous with the first global physical address range.

In some embodiments, the system further includes a second node, wherein: a first node address range includes a range of global physical addresses allocated to the first node; a second node address range includes a range of global physical addresses allocated to the second node; a lowest global physical address of the second node address range exceeds a lowest global physical address of the first node address range by an inter-node address offset equal to a size of the first node address range and equal to a size of the second node address range; and a lowest global physical address of the second global physical address range exceeds a lowest global physical address of the first global physical address range by the inter-node address offset.

In some embodiments, the inter-node address offset is greater than the first size.

In some embodiments, the inter-node address offset is at least a factor of 100 greater than the first size.

In some embodiments, the inter-node address offset is a power of 2.

In some embodiments, the first size is a power of 2.

In some embodiments: the global address translation circuit is configured to map a third global virtual address range having a second size, different from the first size, to a third global physical address range having the second size; the global address translation circuit is configured to map a fourth global virtual address range having a second size to a fourth global physical address range having the second size; and a lowest global physical address of the fourth global physical address range exceeds a lowest global physical address of the third global physical address range by the inter-node address offset.

In some embodiments, the global address translation circuit is further configured to map a first global virtual address to a global physical address or to a local physical address, based on a value of a global bit associated with the first global virtual address.

In some embodiments, the global bit associated with the first global virtual address is a bit of the first global virtual address.

According to an embodiment of the present disclosure, there is provided a method, including: mapping, by a memory management unit of a core of a first node, a local virtual address to a global virtual address, and mapping, by a global address translation circuit of the first node, the global virtual address to a global physical address.

In some embodiments, the memory management unit includes a translation lookaside buffer for mapping local virtual addresses to global virtual addresses.

In some embodiments, the method further includes: mapping, by the global address translation circuit, a first global virtual address range having a first size to a first global physical address range having the first size; and mapping, by the global address translation circuit, a second global virtual address range having the first size to a second global physical address range having the first size, wherein: the second global virtual address range is contiguous with the first global virtual address range; and the second global physical address range is not contiguous with the first global physical address range.

In some embodiments, the method further includes a second node, wherein: a first node address range includes a range of global physical addresses allocated to the first node; a second node address range includes a range of global physical addresses allocated to the second node; a lowest global physical address of the second node address range exceeds a lowest global physical address of the first node address range by an inter-node address offset equal to a size of the first node address range and equal to a size of the second node address range; and a lowest global physical address of the second global physical address range exceeds a lowest global physical address of the first global physical address range by the inter-node address offset.

In some embodiments, the inter-node address offset is greater than the first size.

In some embodiments, the inter-node address offset is at least a factor of 100 greater than the first size.

In some embodiments, the inter-node address offset is a power of 2.

In some embodiments, the first size is a power of 2.

According to an embodiment of the present disclosure, there is provided a system including: a first node, the first node including: a core; and means for global address translation, the core including: a core processing circuit; and a memory management unit configured to map local virtual addresses to global virtual addresses, the means for global address translation being configured to map global virtual addresses to global physical addresses.

### BRIEF DESCRIPTION OF THE DRAWINGS

These and other features and advantages of the present disclosure will be appreciated and understood with reference to the specification, claims, and appended drawings wherein:

FIG. 1A is a system level block diagram, according to an embodiment of the present disclosure;

FIG. 1B is a block diagram showing a central processing unit and associated elements, according to an embodiment of the present disclosure;

FIG. 2A is an address layout diagram, according to an embodiment of the present disclosure;

FIG. 2B is an address layout diagram, according to an embodiment of the present disclosure;

FIG. 3A is an address layout diagram, according to an embodiment of the present disclosure;

FIG. 3B is an address layout diagram, according to an embodiment of the present disclosure;

FIG. 4 is an address layout diagram, according to an embodiment of the present disclosure;

FIG. 5A is a block diagram of a system for mapping global virtual addresses, according to an embodiment of the present disclosure;

FIG. 5B is a block diagram of a portion of a system for mapping global virtual addresses, according to an embodiment of the present disclosure; and

FIG. 6 is a flowchart of a method, according to an embodiment of the present disclosure.

### DETAILED DESCRIPTION

The detailed description set forth below in connection with the appended drawings is intended as a description of exemplary embodiments of a system and method for address translation in a multi-node computing system provided in accordance with the present disclosure and is not intended to represent the only forms in which the present disclosure may be constructed or utilized. The description sets forth the features of the present disclosure in connection with the illustrated embodiments. It is to be understood, however, that the same or equivalent functions and structures may be accomplished by different embodiments that are also intended to be encompassed within the scope of the disclosure. As denoted elsewhere herein, like element numbers are intended to indicate like elements or features.

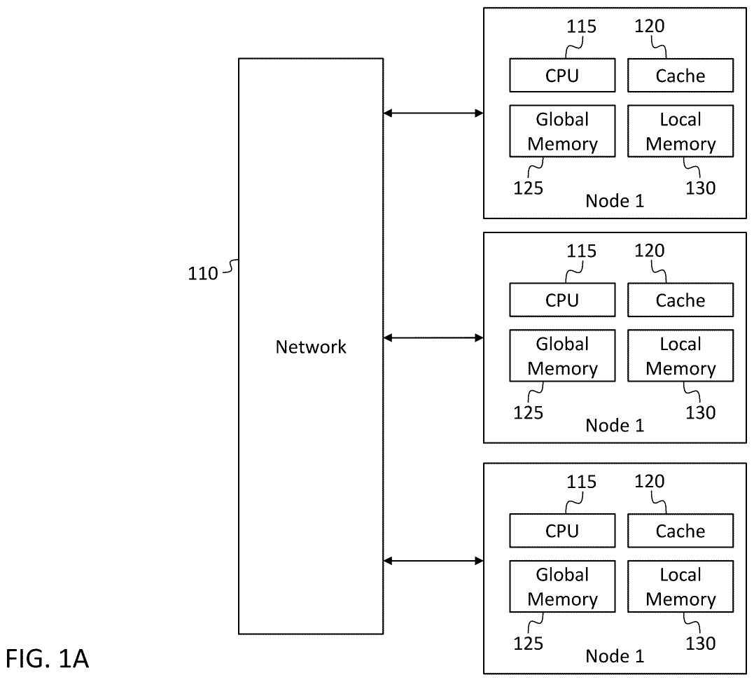

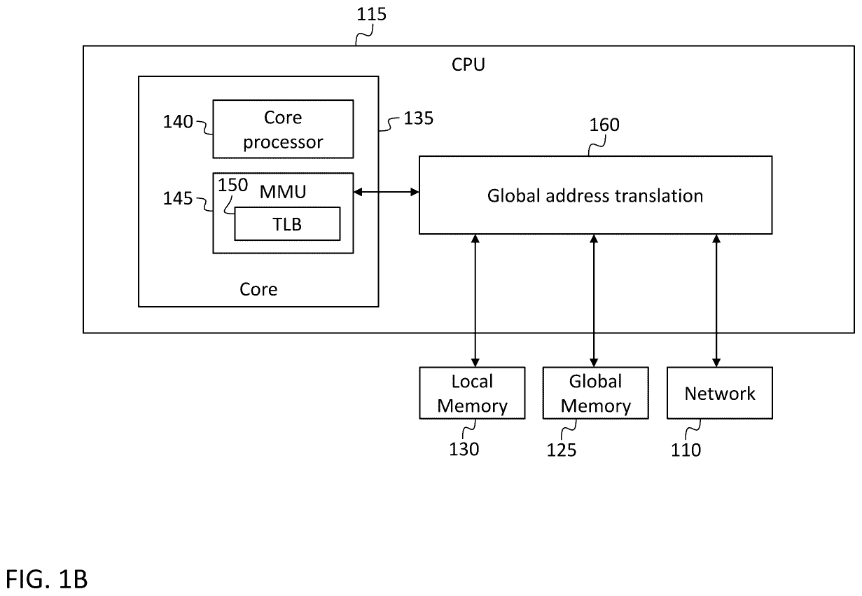

FIG. 1A is a block diagram of a computing system, in some embodiments. A plurality of nodes 105 is connected together by a network 110. Each node includes one or more central processing units (CPUs) 115, one or more caches 120, a global memory section 125 and a local memory 130. Three nodes are shown in FIG. 1 for ease of illustration; some embodiments may include fewer (e.g., two) nodes, or more (e.g., tens, hundreds, or thousands) of nodes. Within each node, cache coherence may be maintained by the hardware of the node, and, as used herein, a “node” is a computing system within which cache coherence is maintained by hardware.

The local memory of each node 105 may be accessible only by the CPU 115 (or CPUs 115) of the node 105. The global memory section 125 of each node 105 may be accessible by all of the nodes 105 including the node 105 (referred to as the “home node” of the global memory section 125) within which the global memory section 125 resides. The global memory sections 125 of all of the nodes may together form a single global memory, and a single global physical addresses space may be used to address data within the global memory.

FIG. 1B shows aspects of the internal structure of a CPU 115, in some embodiments. The CPU 115 may include a core 135, which may be a general-purpose core including a core processing circuit 140 (or “core processor”), and a memory management unit (MMU) 145. The memory management unit 145 may include a translation lookaside buffer (TLB) 150. In operation, applications running in the core processing circuit 140 may use local virtual addresses when executing load and store operations. These local virtual addresses may be translated into addresses referred to herein as global virtual addresses by the memory management unit 145. To perform these translations, the memory management unit 145 may use the translation lookaside buffer 150, which may operate as a lookup table for performing the translations.

The CPU 115 may further include a global address translation circuit 160, which may perform a second layer (or a “second stage”) of translation. For example, the global address translation circuit 160 may receive global virtual addresses from the memory management unit 145, and translate each global virtual address into (i) a local physical address, addressing an address location in the local memory 130 of the node 105, (ii) a global physical address addressing an address location in the global memory section 125 of the node 105, or (iii) a global physical address addressing an address location in the global memory section 125 of another node 105. If the global virtual addresses is translated into a global physical address addressing an address location in the global memory section 125 of another node 105, then the instruction (e.g., the load or store instruction) along with the global physical address may be sent to the network 110.

When the global virtual address is translated into a local physical address, the local physical address may be equal to the global virtual address, or to a portion of the global virtual address (e.g., it may be equal to the n least significant bits of the global virtual address, where n is less than N and the length of the global virtual address is N bits). The determination of whether to translate a global virtual address into a local physical address or into a global physical address may be made based on a bit (referred to herein as a “global bit”) associated with the global virtual address, which may signal (e.g., by having a value of 1 or by having a value of 0) that the global virtual address corresponds to a global physical address. The global bit may be a bit (e.g., the most significant bit) of the global virtual address, or it may be a separate bit (e.g., a separate control bit).

Global physical addresses may be mapped to the nodes 105 in sequence, with, e.g., a first range of global physical addresses, (which may be referred to as a first “node address range”) being mapped to a first node of the system, a second range of global physical addresses, (which may be referred to as a second node address range, and which may be contiguous with the first node address range) being mapped to a second node of the system. Each node of the system may, in this manner, have a respective node address range mapped to it.

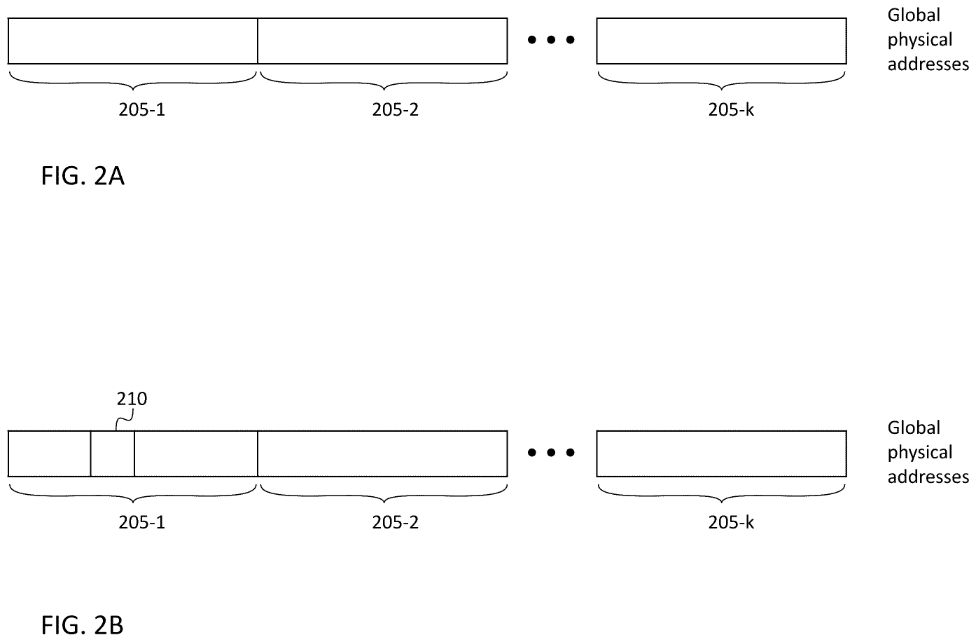

This mapping is illustrated in FIG. 2A. As illustrated in FIG. 2A, in a system with k nodes, the global physical address space is partitioned into k contiguous node address ranges, e.g., a first node address range 205-1 (for a first node 105), a second node address range 205-2 (for a second node), and so on, through a kth node address range 205-k (for a kth node). The size of each of the address ranges, and the difference between the lowest physical addresses of nodes that are adjacent in node number (e.g., the difference between (i) a lowest global physical address of the second node address range and (ii) a lowest global physical address of the first node address range) may be referred to as the “inter-node address offset”.

In some embodiments, the range of global virtual addresses may be mapped directly to the range of global physical addresses (with, e.g., each global virtual address differing by a constant offset from the global physical address to which it is mapped). Such a mapping, however, may be inefficient in certain circumstances. For example, if an array 210 is sufficiently small to fit entirely within the node address range of one of the nodes (e.g., within the first node address range, as illustrated in FIG. 2B), then all load or store accesses to the array, by any of the nodes 105, may be processed by the first node 105, potentially resulting in a bottleneck at the first node 105 and significant burdening of the resources of the first node 105, especially if the array is frequently accessed by the other nodes.

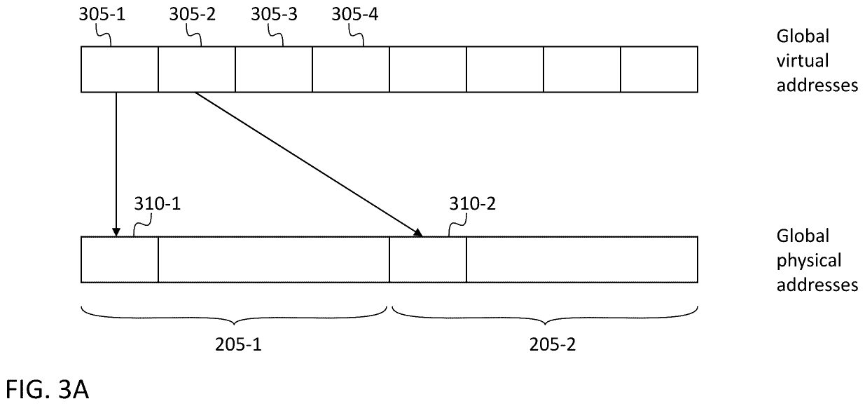

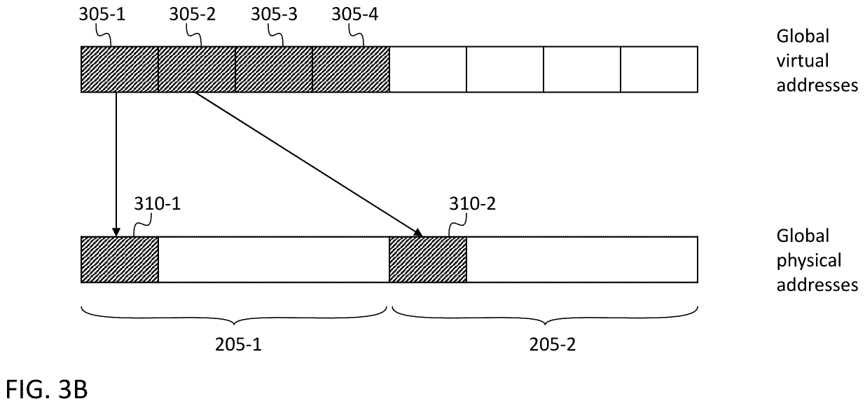

This bottleneck and burdening of the resources of one node may be avoided by using a different mapping from global virtual addresses to global physical addresses. For example the mapping may be hashed or striped. The global address translation circuit 160 may implement such a mapping. FIG. 3A shows an example of a striped mapping, with (i) a first global virtual address range 305-1, having a first size, being mapped to a first global physical address range 310-1, also having the first size, and (ii) a second global virtual address range 305-2, having the first size, being mapped to a second global physical address range 310-2 having the first size. Further ranges of global virtual addresses 305-3, 305-4, may be mapped to corresponding ranges of global physical addresses within the node address ranges of additional nodes 105 (e.g., of a third node 105 and a fourth node 105, not shown in FIG. 3A for ease of illustration).

In this manner, an array may be stored in a plurality of nodes 105, as illustrated in FIG. 3B. For example, if the array occupies the cross-hatched region of the global virtual address space, as shown in the upper portion of FIG. 3B, then each of four portions of the array (305-1, 305-2, 305-3, 305-4) may be stored in a respective one of (i) a first node 105 (in the first global physical address range 310-1), (ii) a second node 105 (in the second global physical address range 310-2), (iii) a third node 105 (in a third global physical address range), and (iv) a fourth node 105 (in a fourth global physical address range). The third and fourth global physical address ranges are not shown in FIG. 3B for ease of illustration.

In some embodiments, the software running in the system may cause each node to address a particular respective portion of such an array more frequently than other portions. For example, in simulation software simulating the behavior of a large number of interacting elements (e.g., atoms in a material, or finite volume portions of such a material, if the material is modeled as being homogeneous), an array may be used to represent certain characteristics of a respective subset of the elements (e.g., stress and strain, or stress and flow velocity). For example, each subset may be a set of neighboring elements which interact primarily with each other, and only to a lesser extent with elements assigned to other nodes. In such a circumstance, the striping of the array across nodes 105, if arranged so that each node 105 stores (in its global memory section 125) the portion of the array that it accesses most frequently, may have the additional benefit that, to the extent that access to a node's global memory section 125 is more efficient than access to a global memory section 125 stored in another node, the speed of execution may be increased, and energy consumption (per computation) may be decreased.

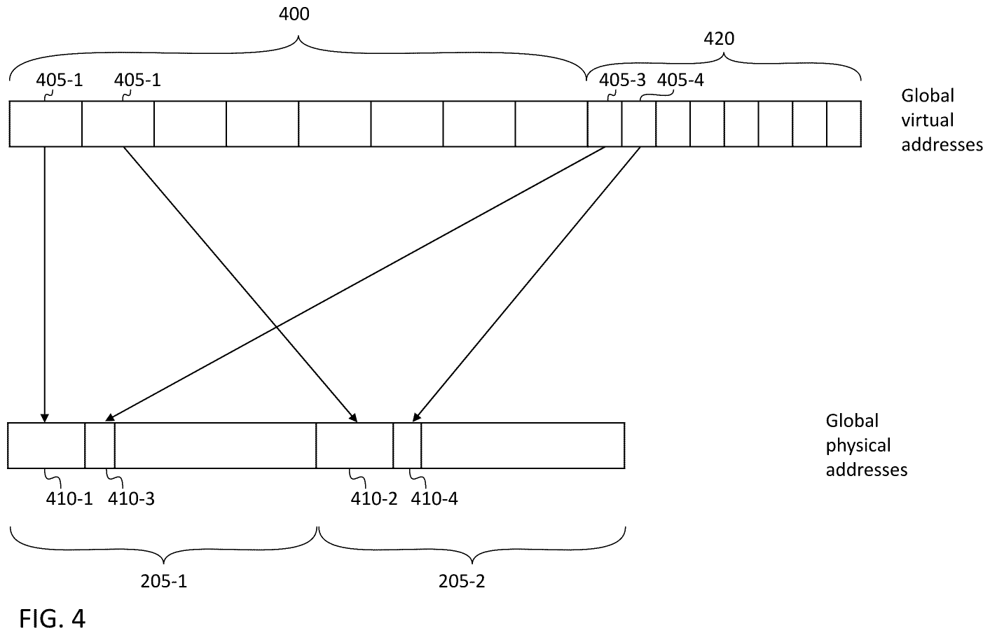

Different portions of the global virtual address space may be divided up into address ranges of different sizes, for purposes of striping. For example, as shown in FIG. 4, within a first portion 400 of the global address space, the global address translation circuit 160 may map a first global virtual address range 405-1 having a first size to a first global physical address range 410-1 having the first size, and the global address translation circuit 160 may map a second global virtual address range 405-2 having the first size to a second global physical address range 410-2 having the first size. The second global virtual address range 405-2 may be contiguous with the first global virtual address range 405-1, and the second global physical address range 410-2 may not be contiguous with the first global physical address range 410-1, as shown. Additional address ranges within the first portion 400 of the global address space may be mapped in an analogous fashion to global physical address ranges within additional nodes (not shown in FIG. 4 for ease of illustration).

Within a second portion 420 of the global address space, the size of each mapped address range (which may be referred to as a second size) may be different from the first size (e.g., smaller than the first size, as illustrated). Within the second portion 420 of the global address space, the global address translation circuit 160 may map a third global virtual address range 405-3 having the second size to a third global physical address range 410-3 having the second size, and the global address translation circuit 160 may map a fourth global virtual address range 405-4 having the second size to a fourth global physical address range 410-4 having the second size. As used herein, “having the first size” or “having the second size” mean having a size equal to the first size or having a size equal to the second size, respectively. The fourth global virtual address range 405-4 may be contiguous with the third global virtual address range 405-3, and the fourth global physical address range 410-4 may not be contiguous with the third global physical address range 410-3, as shown. Additional address ranges within the second portion 420 of the global address space may be mapped in an analogous fashion to global physical address ranges within additional nodes (not shown in FIG. 4 for ease of illustration).

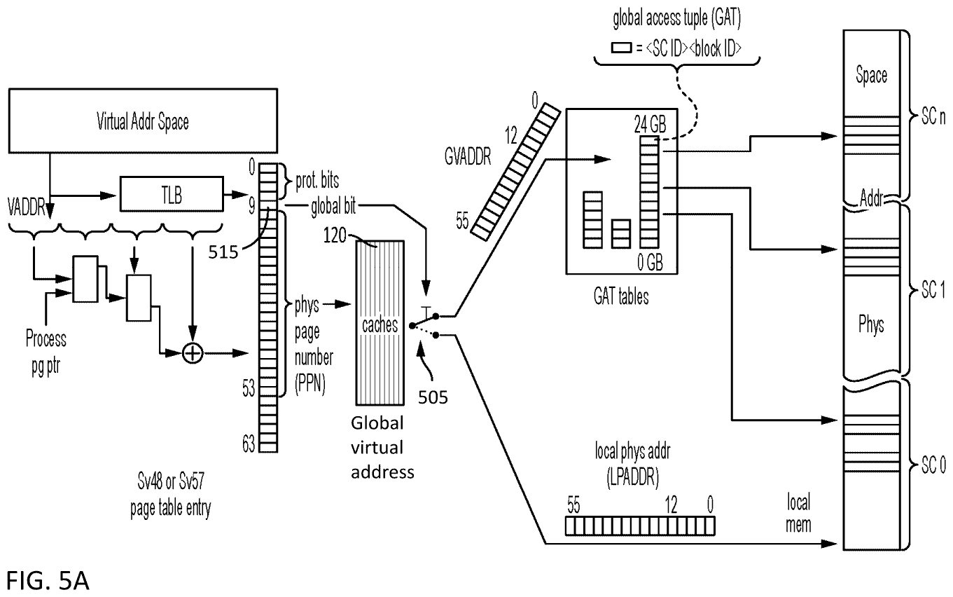

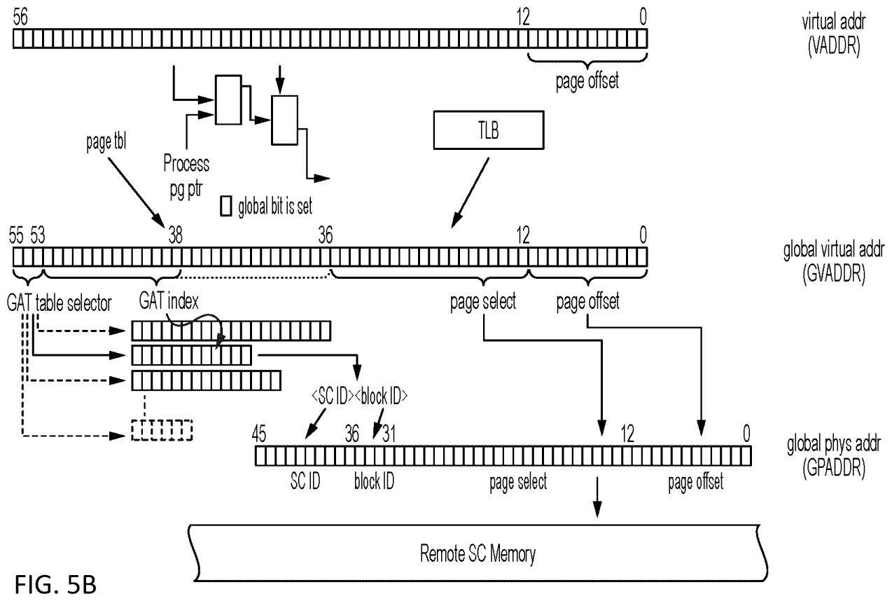

FIG. 5A shows a system for mapping physical addresses (PADDRs) to addresses in the global memory and in the local memories 130. The virtual address used by a CPU is mapped, using a translation lookaside buffer (TLB) and a process page pointer, to a global virtual address, which is fed to one or more caches 120. If a cache miss occurs, then depending on the value of the global bit 515, the global virtual address (or a portion of it) is either (i) directly used as the address into the local memory 130 (if the global bit 515 indicates that the address is an address in local memory) or (ii) if the global bit 515 indicates that the address is an address in global memory), the global virtual address is translated to a global physical address. This selection operation is represented by the switch symbol 505 of FIG. 5A. If the global bit 515 indicates that the address is an address in global memory, then the global virtual address is mapped to a global address tuple (GAT) that includes a node identifier (SC ID) of the home node for the memory at the address, and a block identifier. The portion of FIG. 5A to the right of (and including) the switch 505 may be implemented in the global address translation circuit 160. FIG. 5B illustrates the mapping of the global virtual address to (i) the global address tuple (ii) a page select value and (iii) a page offset value.

The translating performed by the global address translation circuit 160 may be performed by arithmetic or logical operations, which may be significantly more efficient than the use of a lookup table (the size of which may be significant if the number of stripes, and the number of nodes, is large). For example, if the inter-node address offset is a power of 2, then adding J times the inter-node address offset (for a J^{th} node) to a partially-calculated global physical address may involve performing an addition, of (i) J and (ii) a subset of the bits of the partially-calculated global physical address, where the least significant bit of the subset corresponds to the inter-node address offset. Similarly, the size of the global address ranges (and of the corresponding global physical address ranges) may similarly be powers of 2.

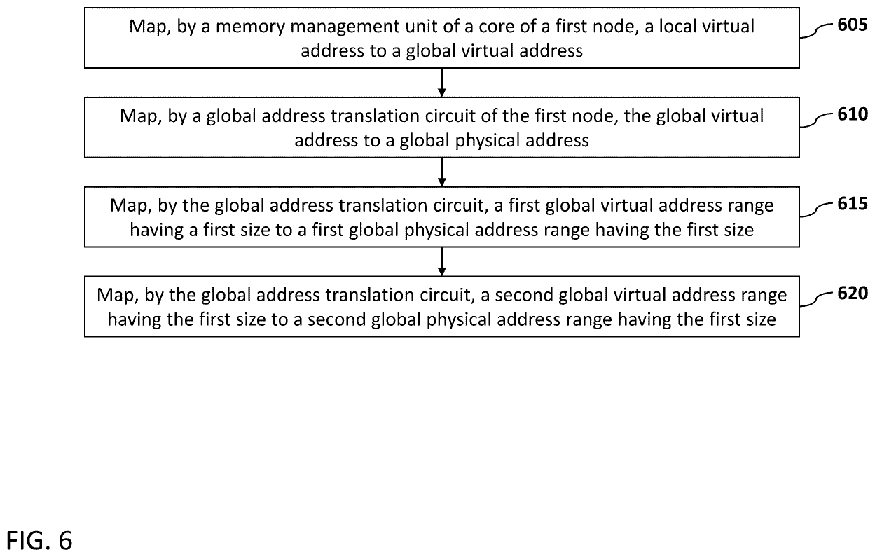

FIG. 6 shows a flowchart, in some embodiments. The method includes: mapping, at 605, by a memory management unit of a core of a first node, a local virtual address to a global virtual address; mapping, at 610, by a global address translation circuit of the first node, the global virtual address to a global physical address; mapping, at 615, by the global address translation circuit, a first global virtual address range having a first size to a first global physical address range having the first size; and mapping, at 620, by the global address translation circuit, a second global virtual address range having the first size to a second global physical address range having the first size.

As used herein, “a portion of” something means “at least some of” the thing, and as such may mean less than all of, or all of, the thing. As such, “a portion of” a thing includes the entire thing as a special case, i.e., the entire thing is an example of a portion of the thing. As used herein, when a second quantity is “within Y” of a first quantity X, it means that the second quantity is at least X−Y and the second quantity is at most X+Y. As used herein, when a second number is “within Y %” of a first number, it means that the second number is at least (1−Y/100) times the first number and the second number is at most (1+Y/100) times the first number. As used herein, the term “or” should be interpreted as “and/or”, such that, for example, “A or B” means any one of “A” or “B” or “A and B”.

Each of the terms “processing circuit”, “means for global address translation”, and “means for processing” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

As used herein, when a method (e.g., an adjustment) or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed herein could be termed a second element, component, region, layer or section, without departing from the spirit and scope of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that such spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

It will be understood that when an element or layer is referred to as being “on”, “connected to”, “coupled to”, or “adjacent to” another element or layer, it may be directly on, connected to, coupled to, or adjacent to the other element or layer, or one or more intervening elements or layers may be present. In contrast, when an element or layer is referred to as being “directly on”, “directly connected to”, “directly coupled to”, or “immediately adjacent to” another element or layer, there are no intervening elements or layers present.

Any numerical range recited herein is intended to include all sub-ranges of the same numerical precision subsumed within the recited range. For example, a range of “1.0 to 10.0” or “between 1.0 and 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Similarly, a range described as “within 35% of 10” is intended to include all subranges between (and including) the recited minimum value of 6.5 (i.e., (1−35/100) times 10) and the recited maximum value of 13.5 (i.e., (1+35/100) times 10), that is, having a minimum value equal to or greater than 6.5 and a maximum value equal to or less than 13.5, such as, for example, 7.4 to 10.6. Any maximum numerical limitation recited herein is intended to include all lower numerical limitations subsumed therein and any minimum numerical limitation recited in this specification is intended to include all higher numerical limitations subsumed therein.

Although exemplary embodiments of a system and method for address translation in a multi-node computing system have been specifically described and illustrated herein, many modifications and variations will be apparent to those skilled in the art. Accordingly, it is to be understood that a system and method for address translation in a multi-node computing system constructed according to principles of this disclosure may be embodied other than as specifically described herein. The invention is also defined in the following claims, and equivalents thereof.

What is claimed is:

1. A system comprising:
a first node,
the first node comprising:
a core; and
a global address translation circuit,
the core comprising:
a core processing circuit; and
a memory management unit configured to map local virtual addresses to global virtual addresses,
the global address translation circuit being configured to map global virtual addresses to global physical addresses.

2. The system of claim 1, wherein the memory management unit comprises a translation lookaside buffer for mapping local virtual addresses to global virtual addresses.

3. The system of claim 1, wherein:
the global address translation circuit is configured to map a first global virtual address range having a first size to a first global physical address range having the first size;
the global address translation circuit is configured to map a second global virtual address range having the first size to a second global physical address range having the first size;
the second global virtual address range is contiguous with the first global virtual address range; and
the second global physical address range is not contiguous with the first global physical address range.

4. The system of claim 3, further comprising a second node, wherein:
a first node address range comprises a range of global physical addresses allocated to the first node;
a second node address range comprises a range of global physical addresses allocated to the second node;
a lowest global physical address of the second node address range exceeds a lowest global physical address of the first node address range by an inter-node address offset equal to a size of the first node address range and equal to a size of the second node address range; and
a lowest global physical address of the second global physical address range exceeds a lowest global physical address of the first global physical address range by the inter-node address offset.

5. The system of claim 4, wherein the inter-node address offset is greater than the first size.

6. The system of claim 5, wherein the inter-node address offset is at least a factor of 100 greater than the first size.

7. The system of claim 5, wherein the inter-node address offset is a power of 2.

8. The system of claim 5, wherein the first size is a power of 2.

9. The system of claim 4, wherein:
the global address translation circuit is configured to map a third global virtual address range having a second size, different from the first size, to a third global physical address range having the second size;
the global address translation circuit is configured to map a fourth global virtual address range having a second size to a fourth global physical address range having the second size; and
a lowest global physical address of the fourth global physical address range exceeds a lowest global physical address of the third global physical address range by the inter-node address offset.

10. The system of claim 2, wherein the global address translation circuit is further configured to map a first global virtual address to a global physical address or to a local physical address, based on a value of a global bit associated with the first global virtual address.

11. The system of claim 10, wherein the global bit associated with the first global virtual address is a bit of the first global virtual address.

12. A method, comprising:
mapping, by a memory management unit of a core of a first node, a local virtual address to a global virtual address, and
mapping, by a global address translation circuit of the first node, the global virtual address to a global physical address.

13. The method of claim 12, wherein the memory management unit comprises a translation lookaside buffer for mapping local virtual addresses to global virtual addresses.

14. The method of claim 12, further comprising:
mapping, by the global address translation circuit, a first global virtual address range having a first size to a first global physical address range having the first size; and
mapping, by the global address translation circuit, a second global virtual address range having the first size to a second global physical address range having the first size,
wherein:
the second global virtual address range is contiguous with the first global virtual address range; and
the second global physical address range is not contiguous with the first global physical address range.

15. The method of claim 14, further comprising a second node, wherein:
a first node address range comprises a range of global physical addresses allocated to the first node;
a second node address range comprises a range of global physical addresses allocated to the second node;
a lowest global physical address of the second node address range exceeds a lowest global physical address of the first node address range by an inter-node address offset equal to a size of the first node address range and equal to a size of the second node address range; and
a lowest global physical address of the second global physical address range exceeds a lowest global physical address of the first global physical address range by the inter-node address offset.

16. The method of claim 15, wherein the inter-node address offset is greater than the first size.

17. The method of claim 16, wherein the inter-node address offset is at least a factor of 100 greater than the first size.

18. The method of claim 16, wherein the inter-node address offset is a power of 2.

19. The method of claim 16, wherein the first size is a power of 2.

20. A system comprising:
a first node,
the first node comprising:
a core; and
means for global address translation,
the core comprising:
a core processing circuit; and
a memory management unit configured to map local virtual addresses to global virtual addresses,
the means for global address translation being configured to map global virtual addresses to global physical addresses.
